(19) United States
(12) Patent Application Publication
(10) Pub. No.: US 2026/0356656 A1
(43) Pub. Date: Nov. 12, 2026

(54) SYSTEMS AND METHODS FOR DISPENSING FOOD PRODUCT

(71) Applicant: Server Products, Inc., Richfield, WI (US)

(72) Inventors: Kyle PERRIN, Richfield, WI (US); Nathan CRAIGHEAD, Richfield, WI (US); Gerald RUSCH, Richfield, WI (US)

(21) Appl. No.: 19/491,711

(22) PCT Filed: Jun. 11, 2024
(86) PCT No.: PCT/US2024/033423

§ 371 Date: Dec. 9, 2025

Related U.S. Application Data
(60) Provisional application No. 63/507,719, filed on Jun. 12, 2023.
(60) Provisional application No. 63/622,863, filed on Jan. 19, 2024.

(51) Int. Cl. B67D 7/38

(52) U.S. Cl. CPC B67D 7/38

(57) ABSTRACT

A food dispenser is configured to dispense a known and repeatable volume of a food product based upon a selection made by the user. The food product dispenser includes one or more pumps, one or more granular dispensers, one or more drive motors, or a control module that is able to accurately control the operation of the one or more pumps or granular dispensers to dispense the desired food product in a selected amount or volume.

### CROSS REFERENCE TO RELATED APPLICATIONS

This patent application claims the benefit of U.S. Provisional Patent Application No. 63/622,863, filed Jan. 19, 2024, and U.S. Provisional Patent Application No. 63/507,719, filed Jun. 12, 2023, each of which is incorporated herein by reference in its entirety.

### BACKGROUND

Food product dispensers can be used to dispense various types of food products, including, for example, flowable flood products, granular food products, etc. Flowable food products can include a wide variety of products, such as condiments (i.e., ketchup, mustard, mayonnaise, tartar sauce, etc.) syrups, dressings, cheeses, fudge, caramel, sauces, wing sauces or other similar food products that can flow and thus be pumped. Flowable food products can include a wide variety of viscosities, non-Newtonian properties, can include small particulates and can be dispensed in a wide range of temperatures from cold to hot. Flowable food products can also be heated food products such as liquid cheese, hot ice cream toppings, or the like or chilled food products such as milk, frozen yogurt, or the like. Granular food products can include a wide variety of products, such as salt, pepper, sugar, seasoning, or other similar food products. Granular food products can include a wide variety of properties including small particulates, large particulates, or the like.

There is a need for a flowable food product dispenser, a granular food product dispenser, or a flowable food product and granular food product dispenser, or the like.

### SUMMARY

The present disclosure generally relates to an automated food product dispenser for dispensing a condiment, sauce, sugar, salt, etc. from a storage container or flexible bag. More specifically, the present disclosure relates to an automated food product dispenser that dispenses one of a plurality of the flowable food products or granular food products in user selected portion sizes in an automated manner. The user selected portion may be a portion determined by the user (e.g., in a manual dispensing mode) or by an electronic controller in accordance with an input from a user or kitchen management system that corresponds with an order being prepared (e.g., a size of a food item, type of food product being dispensed, etc.)

In a first aspect, a food dispenser can include a first chamber and a second chamber, two or more containers contained within the first chamber, at least one pump contained within the second chamber and coupled to a corresponding container of the two or more containers within the first chamber, and a dispenser head attached to the second chamber and configured to dispense a food product from each of two or more containers. In various cases, the at least one pump is configured to pump a flowable food product from the corresponding container to the dispenser head.

In some arrangements, the first chamber is located above a counter and the second chamber is located below the counter. In other cases, a housing comprises the first chamber and the second chamber.

In some instances, the first chamber comprises a first rack, a first connector coupled to the first rack, and a first tube coupling the first connector to the corresponding first container. The food dispenser can further include a second tube coupled to the first connector. In some cases, the second tube extends through a cutout of the first chamber and couples to a second connector coupled to an inlet of the at least one pump in the second chamber. In various instances, the first tube is routed through a cutout in a first back wall of the first chamber and the one or more second connectors are coupled to a second back wall of the second chamber. The food dispenser can further include a third tube and coupling an outlet of the at least one pump to a fitment of the dispenser head.

In various cases, the dispenser head comprises a plurality of fitments. The plurality fitments can be arranged in at least one of one or more rows or one or more columns. The one or more first fitments of the plurality of fitments in a first row can be offset from one or more second fitments of the plurality of fitments in a second row. In some cases, one or more first fitments of the plurality of fitments in a first row are at a first height from a base of the second chamber and one or more second fitments of the plurality of fitments in a second row are at a second height different from the first height from the base of the second chamber. In some arrangements, one or more tubes coupling an outlet of each pump of the at least one pump to a corresponding fitment of the plurality of fitments are arranged along an inner surface of the second chamber based on the first height of the first row and the second height of the second row.

In some cases, the food dispenser can further include a first container of the two or more containers configured to contain a granular food product. The first container can be coupled to the dispenser head and the dispenser head can be configured to dispense the granular food product.

In another aspect, a food dispenser can include at least one first chamber removably coupled to a second chamber, two or more containers contained within the at least one first chamber, at least one pump contained within the second chamber and coupled to a corresponding container of the two or more containers within the first chamber, a dispenser head attached to the second chamber and configured to dispense a food product from each of two or more containers, and controller configured to control the at least one pump to pump a flowable food product from the corresponding container to the dispenser head.

In various cases, the pump comprises a motor and the controller is configured to control the motor of the at least one pump to pump a predetermined amount of flowable food product from the corresponding container through the dispenser head to a vessel. The controller can be configured to control the motor of the at least one pump in response to at least one of a detection of the vessel under the dispenser head or a user selection of a product.

In some instances, the food dispenser can further include a first container of the two or more containers configured to contain a granular food product, the first container can be coupled to the dispenser head, and the dispenser head can be configured to dispense the granular food product. The controller can be further configured to control at least one of a motor coupled to the first container, a knob coupled to the first container, or an opening of the dispenser head coupled to the first container to dispense a predetermined amount of granular food product from the first container to the dispenser head of the at least one pump to pump a predetermined amount of flowable food product from the corresponding container through the dispenser head to a vessel.

In yet another aspect, a food dispenser system can include a first chamber and a second chamber, two or more containers contained within the first chamber, at least one pump contained within the second chamber and coupled to a corresponding container of the two or more containers within the first chamber, and a dispenser head attached to the second chamber and configured to dispense two or more food products simultaneously. The at least one pump can be configured to pump a flowable food product of the two or more food products from the corresponding container to the dispenser head.

The food dispenser system can further include an alignment device configured to align two or more vessels with a corresponding opening of the dispenser head and each dispenser head can be configured to dispense a corresponding food product into the two or more vessels simultaneously.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an isometric view of an example food dispenser, according to aspects of the present disclosure.

FIG. 2 is a front view of the food dispenser of FIG. 1.

FIG. 3 is front view of a plurality of food dispensers according to FIG. 1, shown installed in an under-counter configuration.

FIG. 4 is a partial cross section view of a food dispenser, taken through line IV-IV in FIG. 3.

FIG. 5 is an isometric view of rack for use with the food dispenser of FIG. 1 that is configured to support a container and a pump system.

FIG. 6 is an isometric view of another rack for use with the food dispenser of FIG. 1 that is configured to support a plurality of containers and a pump system.

FIG. 7 is a perspective view of another example food dispenser.

FIG. 8 is an exploded view of the food dispenser of FIG. 7.

FIG. 9 is a perspective view of another example of a food dispenser, according to aspects of the present disclosure.

FIG. 10 is a partial perspective view of the food dispenser of FIG. 9 with portions of a housing removed to show an internal pump system.

FIG. 11 is perspective view of the food dispenser of FIG. 9 further including a cabinet arrangement for storage of food containers in an above-counter configuration.

FIG. 12 is another perspective view of the food dispenser of FIG. 11 with panels of the cabinet arrangement removed.

FIG. 13 is yet another perspective view of the food dispenser of FIG. 11 with panels of the cabinet arrangement removed.

FIG. 14 is a partial perspective view of the food dispenser of FIG. 11 with panels of the cabinet arrangement removed.

FIG. 16 is perspective view of another example of a food product dispenser according to aspects of the disclosure with another configuration for a pump system.

FIG. 17 is another perspective of the food product dispenser of FIG. 16.

FIG. 18 is a perspective view of a storage cabinet configured to house a pump system and one or more food containers.

FIG. 19 is a perspective view of a storage cabinet of FIG. 18 with panels of the storage cabinet removed.

FIG. 20 is another perspective view of a storage cabinet of FIG. 18 showing a back side of the storage cabinet.

FIG. 21 is a cross-sectional view of a dispensing head for a food product dispenser, according to aspects of the disclosure.

FIG. 22 is a cross-sectional view of the dispensing head of FIG. 21 including thermal elements to control a temperature of one or more fitments for a dispensing nozzle.

FIG. 23 is a cross-sectional view of a dispensing head for a food product dispenser including a container for dispensing a granular food product.

FIG. 24 is a perspective view of an interior side of an example nozzle plate for use with the dispensing head of FIG. 21.

FIG. 25 is a perspective view of the nozzle plate of FIG. 24 installed in a dispensing head.

FIG. 26 is a perspective view of another example nozzle plate for use with the dispensing head of FIG. 21.

FIG. 27 is a cross-sectional view of the nozzle plate of FIG. 26.

FIG. 28 is a perspective view of an example alignment device usable with a food dispenser, according to aspects of the disclosure.

FIG. 29 is a perspective view of a food dispenser dispensing a food product into one or more vessels contained within the alignment device of FIG. 28.

### DETAILED DESCRIPTION

Disclosed embodiments will now be described more fully hereinafter with reference to the accompanying drawings, in which some, but not all of the disclosed embodiments are shown. Indeed, several different embodiments may be provided and should not be construed as limited to the embodiments set forth herein. Rather, these embodiments are provided so that this disclosure will be thorough and complete and will fully convey the scope of the disclosure to those skilled in the art.

The disclosed food dispenser will be described with respect to a single serve dispenser (e.g., a dispenser for a single food product) and a multi-serve dispenser (e.g., a dispenser for multiple food products). However, it should be understood that any one or more example arrangements or components of the disclosed single-serve dispenser or multi-serve dispenser could be incorporated in alternate forms of a food dispenser (e.g., a single-serve dispenser, a multi-serve dispenser, an under the counter dispenser, or the like). Furthermore, it should be understood that one or more example arrangements of the disclosed food dispenser could be used outside of the context of a multi-serve food dispenser and could more generally be used in a mechanism and/or mechanisms that dispenses foods. Additionally, although components of the dispensers may be described with respect to a particular arrangement a person of ordinary skill in the art would understand that various components described with respect to one arrangement could be incorporated with other arrangements of the present disclosure and arrangements are not intended to be limited to only the components shown.

In one example, the single-serve or multi-serve food dispenser described below is configured to dispense a known (e.g., predetermined) and repeatable volume of the food product based upon a selection made by the user. The food product dispenser includes one or more pumps, one or more drive motors, or one or more other components (e.g., knobs, suction or vacuum components, automatic openings, or the like), and one or more control units, that are able to accurately control the operation of the one or more pumps, one or more motors, or one or more other components to dispense the desired food product in a selected amount and volume.

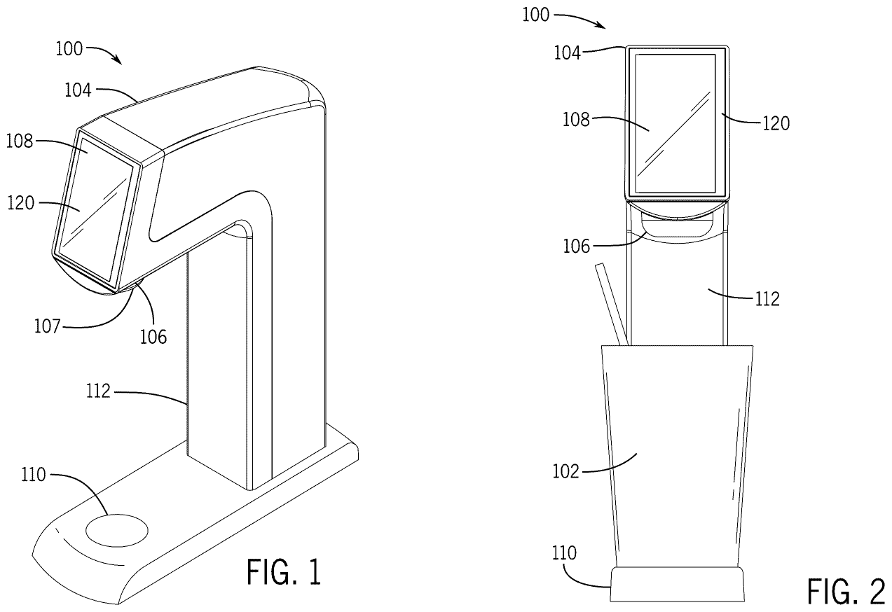

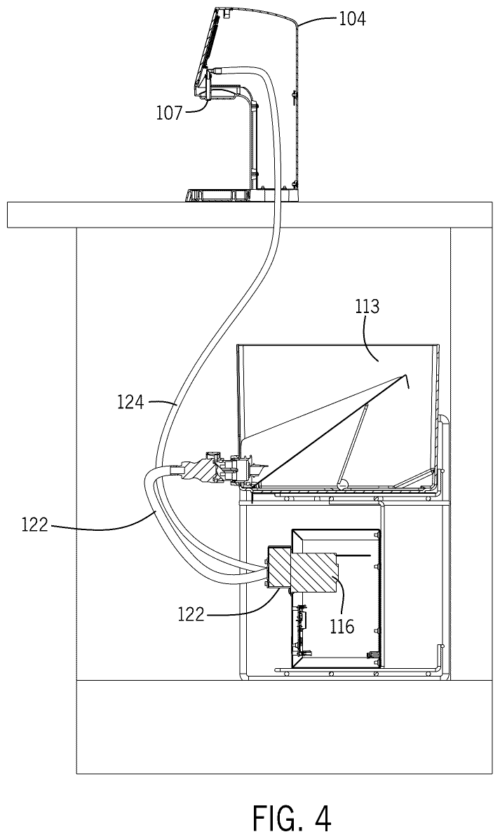

FIGS. 1-4 illustrate non-limiting examples of a first arrangement of a food product dispenser 100 in accordance with various arrangements. The first arrangement of the food dispenser 100 is a single-serve food dispenser which can be configured to dispense a food product. In other words, the food product dispenser 100 is configured to dispense a food product such as a flowable food product, a granular food product, or other food product that can be added to a container or vessel 102 from a food product container.

The food product dispenser 100 can be designed to allow a user to create a custom combination of ingredients/components for a food or liquid product, such as coffee, hot chocolate, tea, ice cream product, or the like. The customized creation is created by dispensing one or more of a number of different types of food products into a vessel 102 (e.g., a cup, a bowl, a plate, a condiment container, a piece of food, or the like) that may be empty or already include a liquid or ice cream. As an example, the food product dispenser 100 can be used to dispense food products such as syrups, flavors, fudge sauces, caramel sauces, condiments, melted cheese, milk, or other similar flowable food products, sugar, salt, pepper, seasoning, or other similar granular food products, or other food products that can be dispensed from either a bottle, container, a flexible food pouch, or the like.

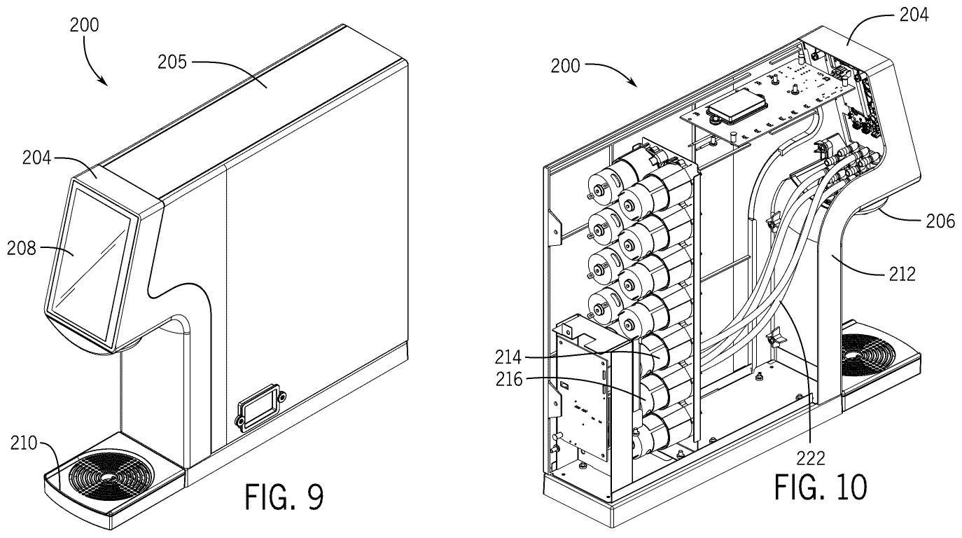

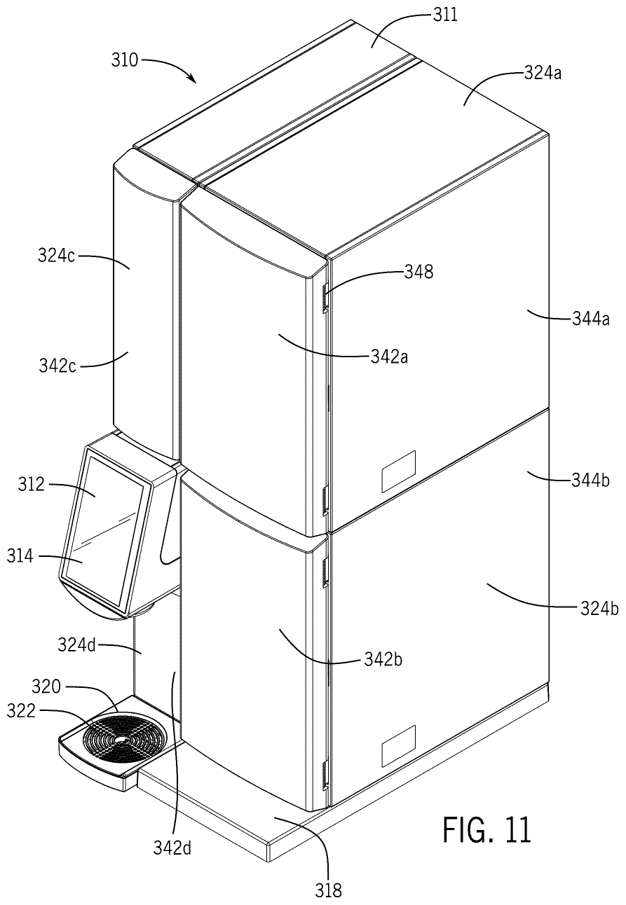

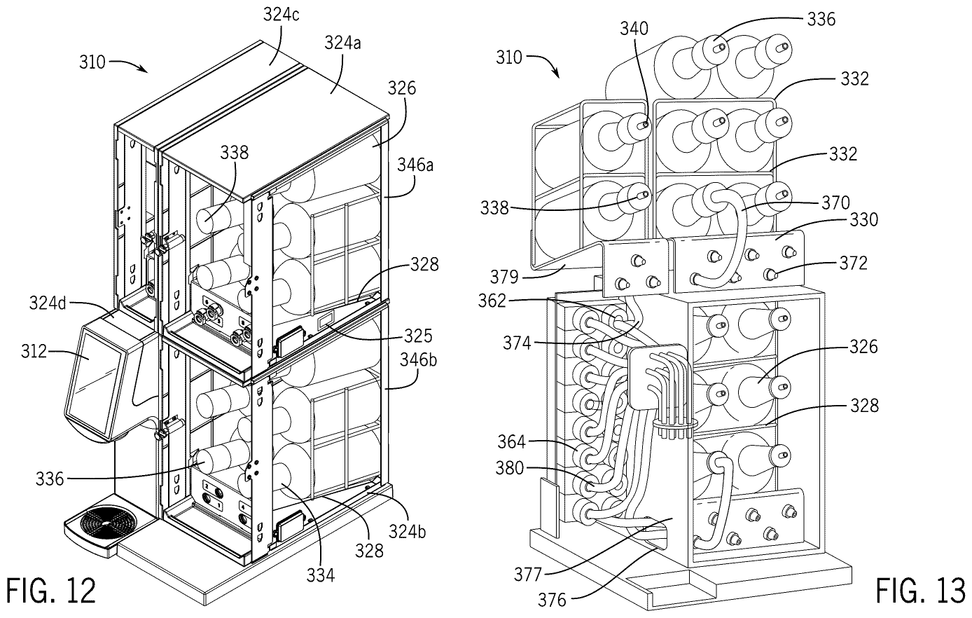

The food dispenser 100 includes a head unit 104. The head unit 104 is configured to attach to at least one of a counter 105, a food dispenser housing (e.g., housing 205 described with respect to FIGS. 9 and 10 or housing 311 described with respect to FIGS. 11-15) or the like. Alternatively, the head unit 104 may be a standalone unit. The head unit 104 can be attached to a counter in a similar manner as described below with respect to head unit 204 of food dispenser 200. In some cases, the counter 105 could be another type of support surface, for example, a wall, a mobile or immobile stand, or the like.

In various cases, the head unit 104 includes a dispensing nozzle 106 and a control module 108. The dispensing nozzle 106 has a single dispensing hole 107. Additionally, the food dispenser 100 includes an optional drip pan 110. A neck 112 of the head unit 104 is sized such that the vessel 102 fits underneath the dispensing nozzle 106.

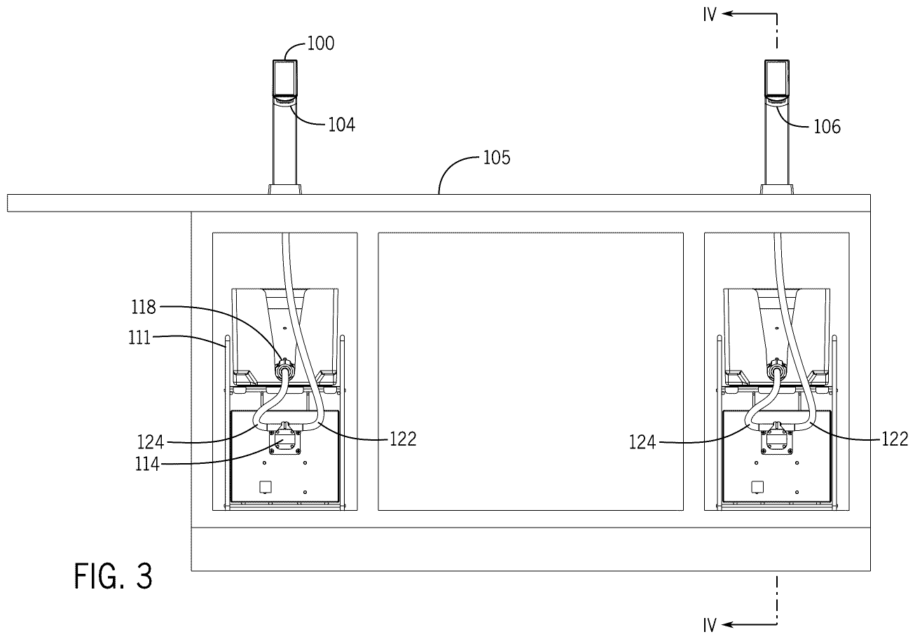

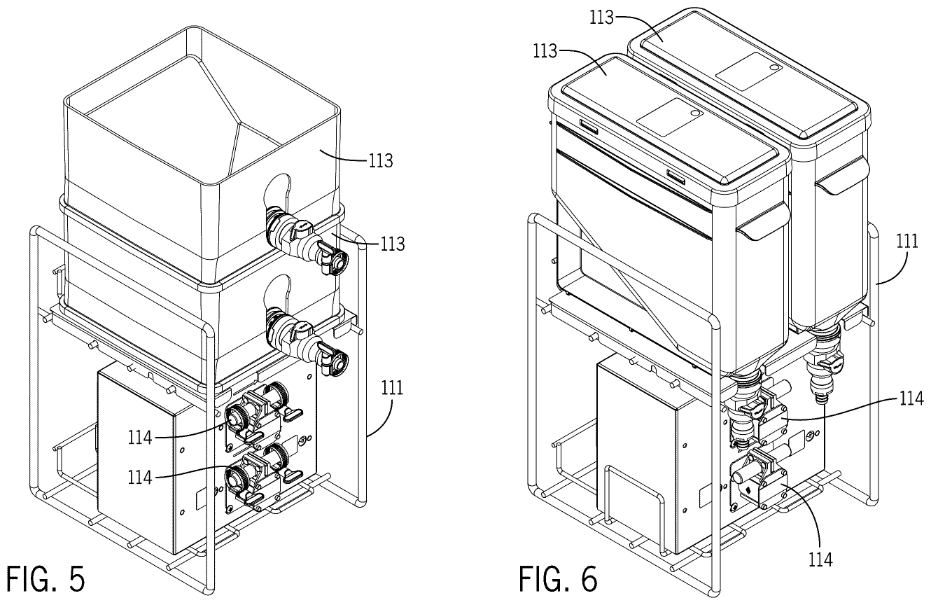

The food dispenser 100 may also include one or more optional housings, shelves, or racks 111 to hold one or more food product containers 113. Each of the one or more racks 111 can be configured to hold one or more food product containers 113 (as shown in FIGS. 3-6). In various cases, the food product containers 113 can be stacked on top of each other (as shown in FIG. 5), stacked side-by-side (as shown in FIG. 6), or stacked in a combination of side-by-side or on top of each other, or the like. In some cases, the one or more food product containers 113 can be one or more bottles, one or more bags, one or more pouches, one or more cans, one or more jars, or the like. In other cases, the one or more food product containers 113 can be configured to contain one or more bottles, one or more bags, one or more pouches, one or more cans, one or more jars, or the like. In some instances, one or more food products can be directly or indirectly poured into the one or more food product containers 113.

The food dispenser 100 can further include one or more pumps 114 and one or more motors 116 configured to dispense a known amount of flowable food product or one or more other types of dispensing systems (described below) to dispense a known amount of granular food product. The number of pumps 114, motors 116, or other components may vary depending on a number of food products that are capable of being dispensed from the dispensing nozzle 106. In the case of food dispenser 100, there is one pump and one motor to dispense a food product (e.g., a flowable food product) from a container. The one or more food product containers 113, pumps 114, motors 116, etc. may be contained under the counter 105, within a food dispenser housing, or within head unit 104. Other types of dispensing systems can be similarly arranged depending on the type of food product being dispensed.

A container fitment 118 can be configured to attach to the one or more food product containers to allow the one or more food products to be dispensed from the one or more food product containers. Dispensing tubing 122 may run from the container fitment 118 to a corresponding pump 114 and dispensing tubing 124 can run from the corresponding pump 114 up through the neck 112 of the head unit 104 to the dispensing nozzle 106.

The control module 108 can include various processors and control elements that allow for controlling the operation of the one or more pumps 114 and the one or more motors 116. Additionally, the control module 108 includes a control panel 120 for receiving input from the user. The control components or the user control panel 120 can allow for touchless or touch activation and the ability to modify the operation of the food dispenser 100 from the user control panel 120.

In operation, a user may place vessel 102 below the dispensing nozzle 106. The control module 108 may then automatically dispense one or more food products based on the detection of the vessel 102. Alternatively, the user may select one or more buttons on the control panel 120 to select one or more types of food products to dispense or a size/amount of a food product to dispense.

When the control module 108 detects a vessel 102 or a user selects the desired food product type or size/amount, the control module 108 selects the required pump 114 or component for operation and makes a determination of the amount of time or the number of rotations the drive motor 116 or other component needs to operate to dispense the size/amount of the food product into the vessel 102.

Once the control module 108 determines the type or amount of food product that needs to be dispensed, the control module 108 initiates the operation of the drive motor 116 for the pump 114 or other component associated with the food product. In the case of a flowable food product, the combination of the drive motor 116 and pump 114 are operable to dispense an accurately known volume of flowable food product for each rotation of the drive shaft. By counting the numbers of rotations of the drive shaft, the control module 108 and motor 116 can accurately meter and control the amount of flowable food product being dispensed from the dispensing nozzle 106. In this manner, the restaurant or food service facility can accurately and repeatedly dispense the desired amount of sauce or other flowable food product into a vessel 102. In other examples, the amount of food product that is dispensed can be controlled based on another operating parameter, for example, the speed or duration of motor operation, a flow meter, a weight measurement, etc. The dispenser 100 can include corresponding sensors in communication with the control module 108 to allow the control module 108 to monitor the operating parameter.

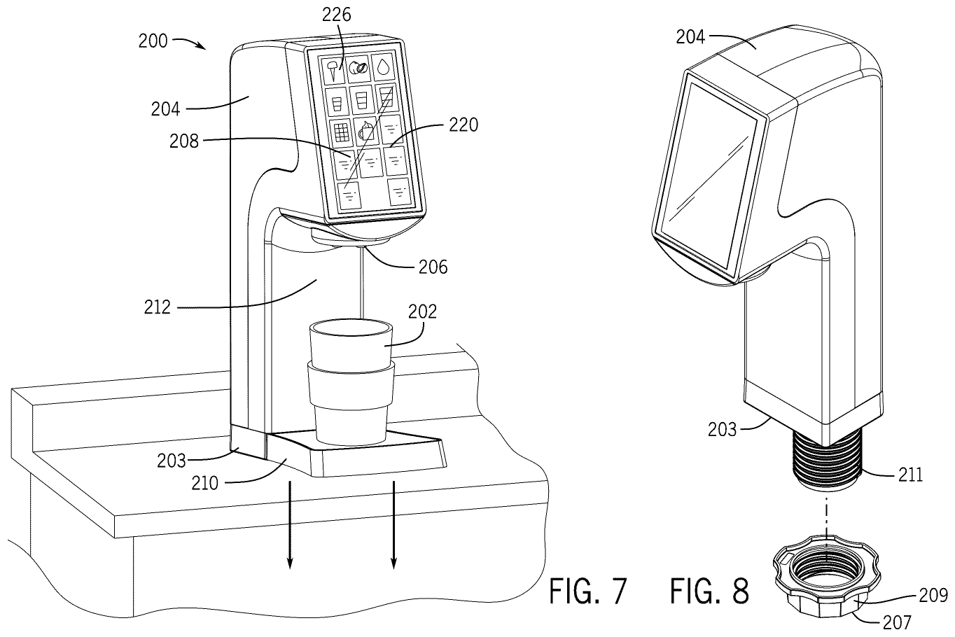

FIGS. 7-10 illustrate non-limiting examples of a second arrangement of a food product dispenser 200. The food product dispenser 200 is a multi-serve food product dispenser. In other words, the food product dispenser 200 is configured to dispense one or more food products from one or more nozzles, either separately or simultaneously. In some cases, the one or more food products can be dispensed from single food product container, or multiple food product containers. The multi-serve food dispenser 200 may function in a similar manner as the single serve food dispenser 100 described above with a few differences.

For example, the food product dispenser 200 can be configured to allow a user to create a custom combination of ingredients/components for a food or liquid product, such as coffee, hot chocolate, tea, ice cream product, hamburger, hotdog, nachos, or the like. The customized creation is created by dispensing one or more of a number of different types of food products into a container or vessel 202 (e.g., a cup, a bowl, a plate, a condiment container, a piece of food, or the like) or onto a desired food item. As an example, the food product dispenser 200 can be used to dispense food products such as syrups, flavors, fudge sauces, caramel sauces, condiments, melted cheese, milk, sugar, salt, pepper, seasoning, or other food products from a container, a flexible pouch, or the like.

The food dispenser 200 includes a head unit 204. The head unit 204 is configured to attach to at least one of a counter 105 (as shown in FIG. 7), a food dispenser housing (e.g., housing 205 shown in FIGS. 9 and 10 or housing 311 described with respect to FIGS. 11-15), or the like. Alternatively, the head unit 204 may be a standalone unit.

When the head unit 204 is attached to the counter 105, a mounting interface 203 (e.g., a bottom portion, or the like) of the head unit 204 can be configured to couple to the counter 105 (or another type of support surface, for example, a wall or a mobile or immobile stand). In some cases, a mounting system 207 can be used to mount the head unit 204 to the counter 105. The mounting system 207 can include a collar 209. The collar 209 can be threaded and configured to attach to one or more corresponding threads 211 on the mounting interface 203 of the head unit 204. In other words, the mounting interface 203 comprising the threads 211 can be inserted through an opening of the counter 105 and the collar 209 can be engaged with the one or more threads 211 to couple the head unit 204 to the counter 105. In other cases, the head unit 204 could be press fit into an opening of the counter 105, adhered to a surface of the counter 105, or another attachment mechanism could be used to couple the head unit 204 to the counter 105.

The head unit 204 includes a dispensing nozzle 206 and a control module 208. The dispensing nozzle 206 has multiple dispenser holes or openings 390 (shown in FIG. 25). Additionally, the food dispenser 200 includes an optional drip pan 210. A neck 212 of the head unit 204 is sized such that the vessel 202 fits underneath the dispensing nozzle 206.

The food dispenser 200 may also include one or more optional housings, shelves, or racks (not shown) to hold one or more food product containers (e.g., bottles, bags, pouches, cans, jars, or the like) similar to FIGS. 3-6 of food dispenser 100. The food dispenser 200 further includes one or more pumps 214, one or more motors 216, or one or more other components configured to dispense a known amount of food product. With regard to flowable food products, the number of pumps 214 and motors 216 may vary depending on a number of flowable products that are capable of being dispensed from the dispensing nozzle 206. In the arrangement shown in FIG. 10, there are fourteen pumps, fourteen motors, and fourteen dispenser holes in dispensing nozzle 206. Other examples may have more or fewer nozzles 206. Thus, the arrangement shown in FIG. 10 can dispense up to fourteen flowable food products from fourteen flowable food product containers. The one or more flowable food product containers, pumps 214, motors 216, etc. may be contained under a counter 105, within a food dispenser housing 205, or within head unit 204.

Dispensing tubing, for example, tubing similar to the dispensing tubing 124 of FIG. 3 or dispensing tubing 374 or 375 of FIGS. 13, 15, or 17, may run from the food product container to a corresponding pump 214 and dispensing tubing 222 can run from the corresponding pump 214 up through the neck 212 of the head unit 204 to the dispensing nozzle 206.

The control module 208 can include various processors and control elements that allow for controlling the operation of the one or more pumps 214, the one or more motors 216, or one or more other components such as one or more components to dispense a granular food product or the like. Additionally, the control module 208 includes a control panel 220 for receiving input from the user. The control module and the control panel 220 (e.g., a user interface) allow for touchless or touch activation and the ability to modify the operation of the dispenser 310 from the user control panel 220. The control panel 220 can include multiple buttons (physical or virtual), which can, for example correspond to a different type of food product or a size of a food product to dispense.

The operation of food dispenser 200 is similar to the food dispenser 100 (described above) except that that user has the ability to choose one or more food products and one or more food products may be dispensed, separately or simultaneously.

In some cases, similar functionalities described above with respect to food dispenser 100 and 200 may be implemented within the food dispensers described below. For example, FIG. 11 illustrates a non-limiting example of a third arrangement of a food product dispenser 310 according to aspects of the disclosure. The food product dispenser 310 can be a single-serve food product dispenser or a multi-serve food product dispenser. For the single-serve food product dispenser, the food product dispenser 310 can be configured to dispense one food product. For the multi-serve food product dispenser, the food product dispenser 310 can be configured to dispense two or more food products.

As illustrated in FIG. 11, the food product dispenser 310 includes a housing 311 and control module 312. The control module 312 includes a user control panel 314 that allows the user to select the flavors to be added to a container(e.g., vessel 102 or 202, a coffee cup, a bowl, a plate, a condiment cup, a jar, a piece of food, or the like). The food product dispenser 310 further includes a base 318 designed to rest upon a support surface, such as a tabletop or counter and includes a support 320 (e.g., an optional drip tray or the like) designed to support the container during the dispensing process. In some cases, the support 320 may not be level with a top surface of the base 318 and may have a cutout or the like to receive the container 316. Alternatively, in other cases, the support 320 is level with the top surface of the base 318. In some cases, there may be one or more slots 322 located in the support 320. The one or more slots 322 are configured to allow liquid to drip through to an interior of the base 318 such that the liquid does not stay on top of the support 320.

The food product dispenser 310 further includes one or more chambers 324a-324d (collectively, chambers 324) within housing 311. Although four chambers 324a-324d are shown in FIGS. 11-15, there may be more or less chambers 324a-324d depending on a number of flavors to be dispensed by the food dispenser 310. In a non-limiting example, a single-serve dispenser can only have one chamber (e.g., a chamber configured to house a food product container and a pump, electronics, or the like) or two chambers (e.g., a first chamber 324c to house a food product container and a second chamber 324d to house a pump, electronics, or the like). The one or more chambers 324a-324d may removably couple to one another and be modular such that different configurations of the food dispenser 310 may be obtained and the total number of flavors to be dispensed by the food dispenser may be increased or decreased. This removable attachment between modules may be obtained using screws, magnets, clips, or the like. Additionally, the one or more chambers 324a-324d can be different sizes and are not limited to the sizes and configurations shown.

Chambers 324a-324c can contain one or more containers 326 (e.g., bottles, bags, pouches, cans, jars, or the like) containing food products as shown in FIGS. 11-13. In some instances, chambers 324a and 324b can be configured to hold six containers 326 while chamber 324c can be configured to hold two containers 326. However, each chamber 324a-324c can be configured to hold more or less containers 326 than the ones shown. The one or more containers 326 can be different sizes or types (e.g., bottles, bags, pouches, cans, jars, or the like). The containers 326 could be formed from different types of materials, such as plastic or glass. Additionally, the containers 326 can be configured as single-or multi-use containers, including for direct-pour applications.

In some cases, the one or more chambers 324a-324d can be heated or cooled to dispense food products at different temperatures. In a non-limiting example, a chamber (e.g., chamber 324a) may be cooled to dispense milk or frozen yogurt while a chamber (e.g., chamber 324b) may be heated to dispense hot fudge or coffee. In various cases, the one or more chambers can contain one or more thermal elements 325 (e.g., heating or cooling elements) to control a temperature of the food products therein. In some instances, the one or more chambers can be lined with heat shielding or one or more thermally insulating materials to maintain the chambers at a constant temperature and reduce energy consumption. The heat shielding or one or more thermally insulating materials can be located between an outer surface of the chamber (e.g., top surface, bottom surface, front surface, back surface, etc.) and an inner surface (e.g., top surface, bottom surface, front surface, back surface, etc.) of the housing 311 or an outer surface (e.g., top surface, bottom surface, front surface, back surface, etc.) of another chamber. The heat shielding and/or one or more thermally insulating materials can include, without limitation, polystyrene, urethane, polyurethane, cellular glass, glass wool, or other insulating material, or combination of insulating materials, or the like) to maintain the chambers at a constant temperature. In some cases, the tubing (e.g., dispensing tube 370, 374, 375, 380, or the like) associated with the food products at different temperatures can be insulated to maintain a temperature within the tubing.

The one or more containers 326 can be held on one or more racks 328. The one or more racks 328 can be removable. In some cases, one or more racks 328 of different sizes or types may be provided to accommodate one or more containers 326 of different sizes or types. The one or more racks 328 can also be angled to allow for easy insertion and removal of the one or more containers 326. Alternatively, in other cases, only a lower portion 330 of the one or more racks 328 can be angled while the upper portions 332 are not angled.

The one or more containers 326 can include a connector 334 (e.g., a neck of a bottle, a portion of a bag, etc.) configured to connect to a container fitment 336. The container fitment 336 can be a universal fitment configured to connect to one or more containers 326 of different sizes or types. The container fitment 336 may be formed from silicon or rubber, or the like. By forming the container fitment 336 from silicon or rubber the container fitment 336 is able to deform and seal against containers 326 or connectors 334 of containers 326 of different sizes or types. The container fitment 336 allows for the quick connect/disconnect of the container 326 from the food dispenser 310. Additionally, the container fitment 336 has protrusion 338 and an opening 340 to allow the food product to dispense from the container 326 through the container fitment 336.

The container fitment 336 can incorporate a check valve to allow for the flow of atmosphere into the containers 326 without allowing the food product to dispense out of the containers 326. This eliminates the need for an external supply of air to maintain consistent pressure inside of containers 326 and enables consistent and accurate portioning with no bubbles in a supply line.

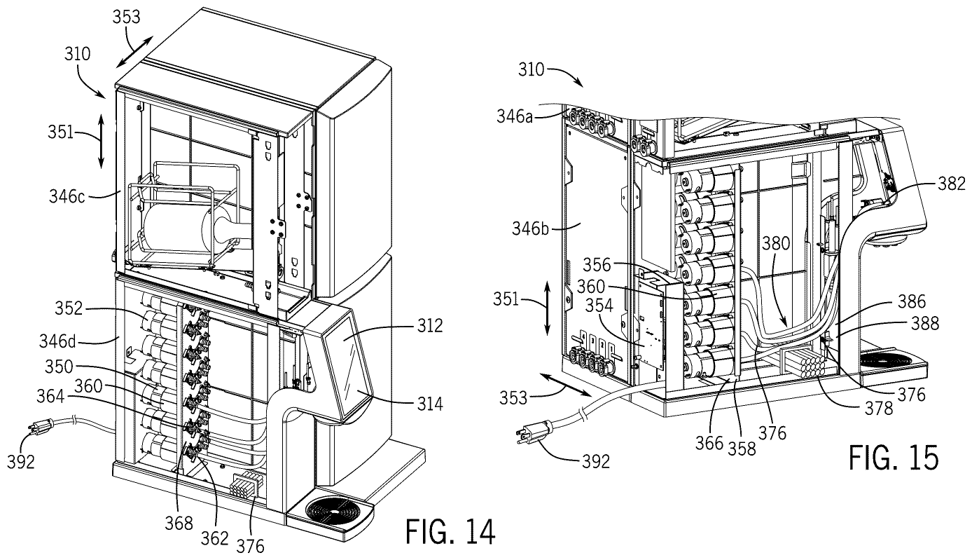

Each chamber 324a-324d can have one or more removable or openable front panels 342a-342d (shown in FIG. 11), side panels 344a-344d (of which only 344a and 344b are shown in FIG. 11), or back panels 346a-346d (shown in FIGS. 14 and 15). In some instances, the one or more panels are configured to be opened and have one or more hinged connections 348. In this way, the one or more containers 326 are easily removed from the food product dispenser 310, parts of the food dispenser 310 are easily replaced, and maintenance is easily performed on the food dispenser 310.

In some examples, a dispensing system can be arranged so that the controls, a pump system, and other components that control dispensing of the flowable food product can be retained separately from food products. For example, chamber 324d may contain one or more pumps 350, one or more motors 352, one or more processors 354, one or more electronics, one or more power supplies 356, one or more other components, or the like. By housing the one or more pumps 350, one or more motors 352, one or more processors, and one or more electronics separately from the one or more containers 326 in chambers 324a-324c, it is less likely that the one or more pumps 350, one or more motors 352, one or more processors, and one or more electronics will be damaged by the food products contained within the one or more containers 326. This is because the one or more pumps 350, one or more motors 352, one or more processors, and one or more electronics are separated from the one or more containers 326. Additionally, electronic components may generate heat during operation and storing the components in a separate cabinet can help reduce heat transfer to any food products.

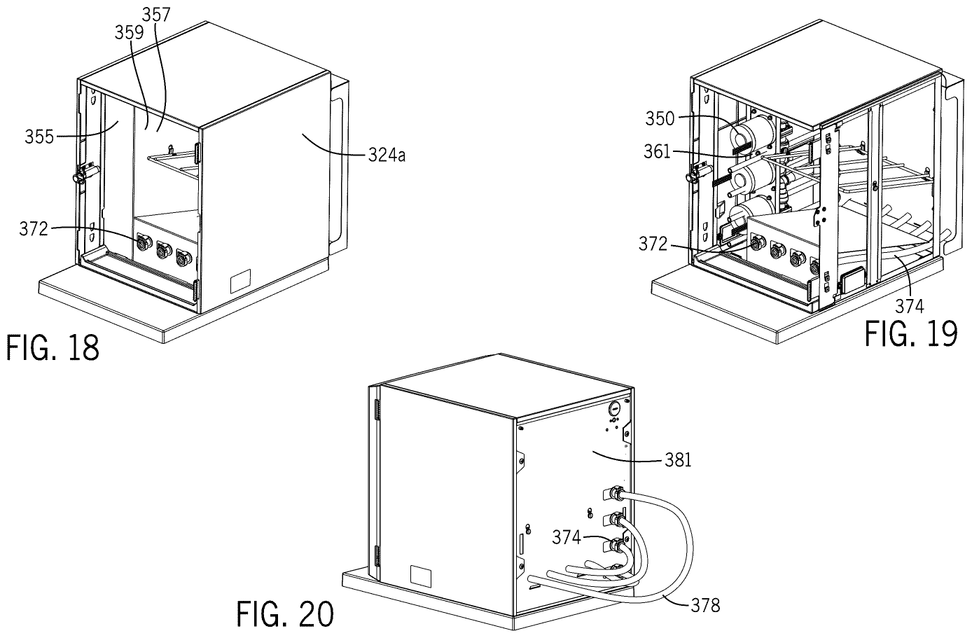

In some cases, as shown in FIGS. 18-20, the one or more pumps 350, one or more motors 352, one or more processors 354, one or more electronics, one or more power supplies 356, or the like may be contained within a separate portion 355 of the one or more chambers 324a-324c. For example, as shown in FIG. 18, chamber 324a can include one or more food products in a first portion 357 of chamber 324a while the one or more pumps 350, one or more motors 352, one or more processors 354, one or more electronics, one or more power supplies 356, or the like are contained within the separate portion 355 of the chamber 324a. The food products can be separated from the one or more pumps 350, one or more motors 352, one or more processors 354, one or more electronics, one or more power supplies 356, or the like by a sidewall 359. By housing the one or more pumps 350, one or more motors 352, one or more processors, one or more electronics, or the like within the separate portion 355, it is less likely that the one or more pumps 350, one or more motors 352, one or more processors, and one or more electronics, or the like will be damaged by the food products contained within the first portion 357 of the chamber 324a. This is because the one or more pumps 350, one or more motors 352, one or more processors, and one or more electronics, or the like are separated from the one or more containers 326.

A first wall 358 of chamber 324d or a first wall 361 of chamber 324a is designed to support the one or more pumps 350. The first wall 358 or the first wall 361 could be a top wall or back wall of chambers 324d or 324a or a wall that is separate from one or more walls of chambers 324d or 324a. One or more collars 360 are coupled to the first wall 358 of chamber 324d or first wall 361 of chamber 324a. The one or more collars 360 are configured to quickly and efficiently couple each pump and corresponding motor with the first wall 358 or first wall 361. The one or more collars 360 allow for a quick connect/disconnect between the first wall 358 or first wall 361 and the one or more pumps 350 or motors 352. In this way, a user of the food dispenser 310 can easily remove and add one or more pumps 350 and motors 352 to the food dispenser 310.

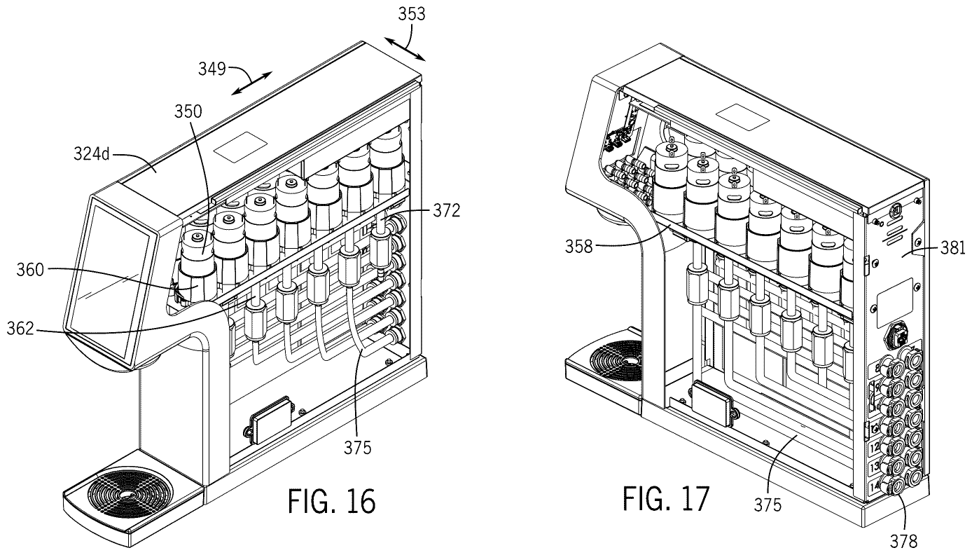

The one or more pumps 350 are each associated with one of the containers 326. In other words, there is a one-to-one relationship between each pump 350 and each container 326 so if there are six containers 326, then there are six pumps 350. In some cases, pumps 350 can be arranged differently and a single pump 350 may be associated with multiple containers 326. In some cases, one or more of the pumps 350 may be unused. In the arrangement shown in FIGS. 13 and 14, there are fourteen pumps 350 organized in a pump array, one for each of the fourteen containers 326 housed within chambers 324a-324c. The one or more pumps 350 may be aligned within the pump array along a first axis A-A (e.g., a vertical axis shown in FIG. 14) and a second axis B-B (e.g., a horizontal axis shown in FIG. 13). In the arrangements shown in FIGS. 13-15, the pumps 350 are aligned with seven pumps along the first axis 351 (e.g., a vertical axis) and two pumps aligned along the second axis 353 (e.g., a horizontal axis oriented along a width of the dispenser 310). However, other configurations are possible. For example, FIGS. 16 and 17 show an alternative arrangement with seven pumps along a third axis 349 (e.g., a second horizontal axis oriented along a depth of the dispenser 310) and two pumps aligned along the second axis 353. By aligning the pumps 350 in an array, the pumps 350 may be easily organized and tubing attached to the one or more pumps 350 may also be easily organized and managed.

In some arrangements, the one or more pumps 350 are flexible impeller pumps, such as the Server Pump™ sold by Server Products. However, other types of pumps could be used as long as the pumps can be accurately controlled to dispense a known volume of the flowable food product upon operation.

The pumps 350 include an inlet 362 and an outlet 364 and are each operable to pump a flowable food product from the inlet 362 to the outlet 364. In some cases, as shown in FIGS. 14 and 15, the one or more pumps 350 are arranged on a first side 366 of first wall 358 while the inlet 362 and the outlet 364 of the pumps 350 extend through the first wall 358 to a second side 368 of the first wall 358. In this way, the tubing attached to the one or more pumps 350 may be easily organized and managed. In other cases, the inlet 362 of the one or more pumps 350 is arranged on a first side 366 of first wall 358 while the outlet 364 of the one or more pumps 350 extends through the first wall 358 to a second side 368 of the first wall 358. This way of setting up the pumps 350 also has the advantage of allowing the tubing to be easily organized and managed.

As shown in FIG. 13, each of the containers 326 can be connected to a first end of a first dispensing tube 370 that extends from the container 326 to a first connector 372. The first dispensing tube 370 is a flexible tube that sealingly engages with the protrusion 338 (e.g., a barbed connector, a threaded connector, a quick-connect fitting, etc.) of the container fitment 336. A corresponding pump of the one or pumps 350 is configured to pump a flowable food product from the container 326 through the container fitment 336 through the first dispensing tube 370 to the first connector 372. The first connector 372 connects to a second end of the first dispensing tube 370. The first connector 372 is connected to a corresponding inlet of a pump via a second dispensing tube 374. Alternatively, in some cases, there is no first connector 372, and the first dispensing tube 370 connects the container 326 directly to a corresponding inlet of a pump. The one or more first connectors 372 may be labeled to allow for easy identification of which first connector 372 corresponds to a particular flavor or pump. This ensures that the one or more flavors are not mixed with each other.

In some examples, the one or more second dispensing tubes 374 can be located underneath the lower portion 330 of the one or more racks 328. Because rack 328 is angled, the second dispensing tubes 374 easily fit underneath the rack 328 which further improves the organization and management of the second dispensing tubes 374.

The one or more second dispensing tubes 374 are configured to enter the fourth chamber 324d or the separate portion 355 of the chamber 324a via one or more cutouts or openings 376 between the chambers 324a-c and chamber 324d. In various cases, the one or more cutouts 376 can be located in a sidewall 377 between the chambers (shown in FIG. 13), for example, in a bottom or top wall 379 between the chambers (shown in FIG. 13) or a back wall 381 of the chambers 324 (shown in FIGS. 17 and 20). In other words, the dispensing tubes 374 can be routed through one or more sidewalls, top walls, or bottom walls of the chambers, around one or more backwalls of the one or more chambers, or the like. In some cases, the one or more cutouts 376 can be one or more holes. When the cutouts 376 are one or more holes, a first end of the one or more second dispensing tubes 374 is connected to the one or more first connectors 372 while a second end of the one or more second dispensing tubes 374 is connected to the inlet 362 of a corresponding pump 350. Alternatively, in other cases, the one or more cutouts can include one or more second connectors 378. For example, FIG. 17, shows second connectors 378 provided along a back wall of the dispenser 310, which allows tubing to be connected between the containers and the pumps 350 from the exterior of the dispenser 310. When there are one or more second connectors 378, a first end of the second dispensing tube 374 is connected to the first connector 372 while a second end of the second dispensing tube 374 is connected to the second connector 378. The one or more second connectors 378 can be labeled to allow for easy identification of which second connector 378 corresponds to a particular flavor or pump. Then, a third dispensing tube 375 can connect the second connector 378 to the inlet 362 of the pump 350. By adding the second connectors 378 between the chambers 324a-c and 324d, the tubing attached to the one or more pumps may be easily organized and managed and the tubing can be quickly connected and disconnected from the second connectors 378.

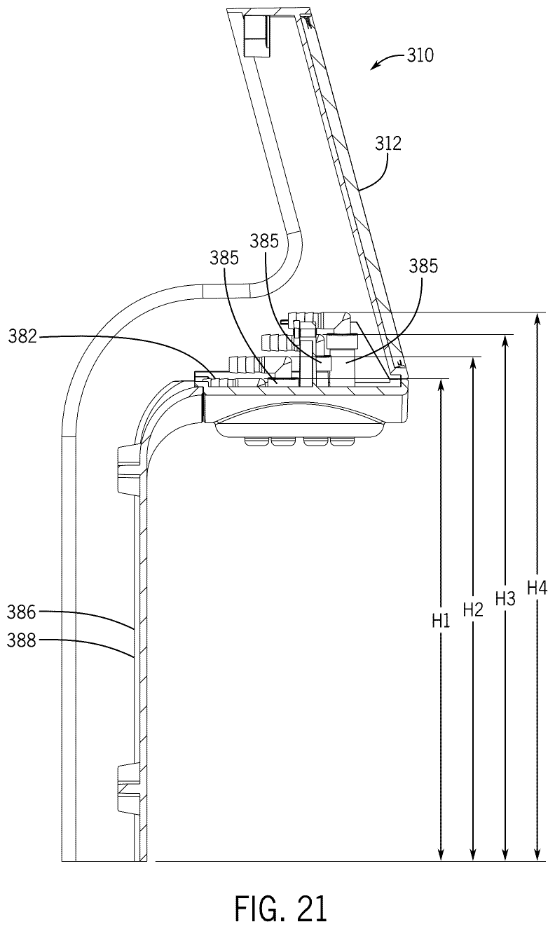

A first end of a fourth dispensing tube 380 (shown in FIGS. 13 and 15) is connected to the outlet 364 of pump 350. A second end of the fourth dispensing tube 380 is then connected to a corresponding dispensing fitment 382 coupled to a dispenser head 384. FIGS. 21-27 show additional arrangements of the dispenser head 384. The fourth dispensing tubes 380 may be configured to couple to the control module 312. Here, the tubes 380 run along an inner surface 386 of a second wall 388. One or more clips (not shown) may be provided to couple the fourth dispensing tubes 380 to the inner surface 386 of second wall 388. The flowable food product can be pumped through the outlet 364 of pump 350 through the fourth dispensing tube 380 through the dispensing fitment 382 and flow out of one or more openings 390 of the dispenser head 384.

The dispensing fitment 382 may be formed from plastic, metal, other rigid material, or the like. The dispensing fitments 382 can be integrally formed within dispenser head 384. The dispensing fitments 382 can have a 90-degree angle or elbow. By angling or elbowing the dispensing fitment 382 90 degrees, the one or more food products are more easily dispensed from the dispensing fitments 382 while also ensuring that the fourth dispensing tubes 380 do not get kinked.

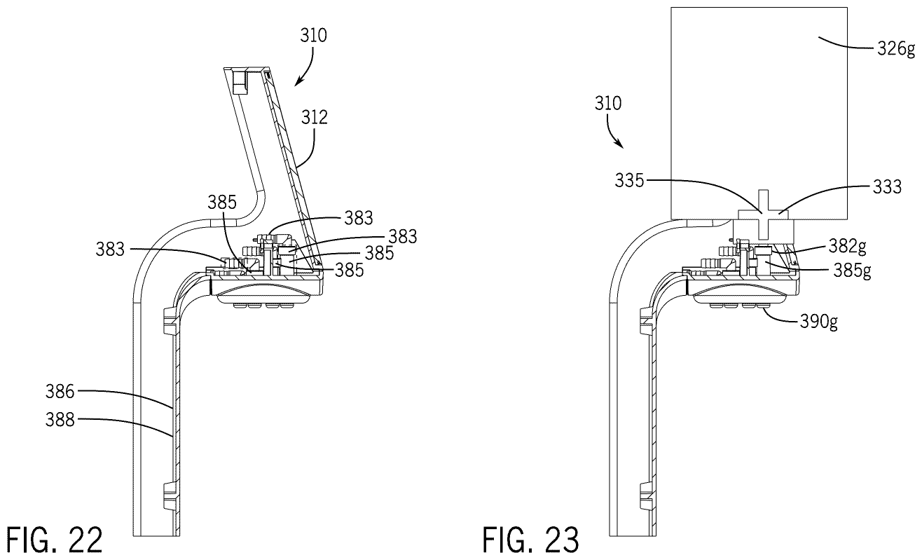

In some cases, the one or more dispensing fitments 382 can be heated or cooled to dispense food products at different temperatures (e.g., cold milk, hot fudge, etc.). In various cases, as shown in FIG. 22, a thermal element 383 can be coupled to a corresponding fitment 382 to directly cool the corresponding fitment 382 (e.g., to provide heating or cooling at a dispensing location, such as a nozzle). In some cases, a thermal element 383 can be configured to heat the fitment 382 or to cool the fitment 382. A thermal elements 383 that heat and cool the fitments 382 can be used in the same dispenser based on the type of food product being dispensed. In some cases, the thermal element 383 can surround an outer surface a corresponding fitment 382. In various cases, each fitment 382 can be coupled to a thermal element 383. Alternatively, in other cases, the thermal elements 383 may only be coupled to selected fitments configured to dispense a food product at a specific temperature. In some cases, the thermal element 383 can further be coupled to or selectively coupled to the one or more dispensing tubes (e.g., first dispensing tube 370, second dispensing tube 374, third, or fourth dispensing tube 380, or the like).

In some cases, the dispensing head 384 can have one or more extension tubes 385. Although the extension tubes 385 are described throughout this disclosure as cylindrical, other shapes (e.g., square, rectangular, conical, or other shape, or the like) or configurations are possible and the extension tubes 385 are not limited to only being cylindrical. Each extension tube 385 can have a corresponding opening 390 extending through the extension tube 385. A first end of the extension tube 385 can be configured to couple to the one or more fitments 382. In some cases, the one or more extension tubes 385 can be integrally formed with the dispensing head 384. The food product can be dispensed through the dispensing fitment 382 and a corresponding extension tube 385 and be dispensed out of a corresponding opening 390 of the dispenser head 384. In some cases, the one or more extension tubes 385 can be heated or cooled to dispense food products at different temperatures (e.g., cold milk, hot fudge, etc.). For example, in some cases, the thermal element 383 could further be coupled to or selectively coupled to the one or more extension tubes 385. In various instances, the heating or cooling element 383 can surround an outer surface of a corresponding extension tube 385.

In some example, a dispensing system can be configured to different multiple types of food products. For example, the one or more dispensing fitments 382 or extension tubes 385 can be configured to dispense a granular food product (e.g., salt, sugar, granola, sprinkles, etc.). In various cases, as shown in FIG. 23, a granular food product container 326g can be coupled to a corresponding fitment 382g or extension tube 385g to dispense a granular food product. In various cases, the granular food product container 326g could be contained within chamber 324c, another chamber, under a counter (see e.g., dispensing systems 100, 200), or the like. In some cases, the fitment 382g can be used to dispense a granular food product using gravity, a vacuum, a conveyor, or the like. In various cases, one or more knobs 333, motors 335, or the like can be used to control an amount of granular food product that is dispensed from the granular food product container 326g. In some cases, an opening 390g of the fitment 382g can be configured to open for a specific amount of time or the one or more knobs or motors can be configured to turn a specific amount to cause the food dispenser 310 to dispense a specific or controlled amount of granular food product. The opening 390g of the fitment 382g can be sized control the amount of granular food product dispensed. While FIG. 23 shows the granular food product container 326g coupled directly to the head of the dispenser 310 via a dispensing fitment 382g, in other examples, the granular food product container 326g can be indirectly coupled to the dispensing fitment 382 via tubing (e.g., dispensing tubing 222).

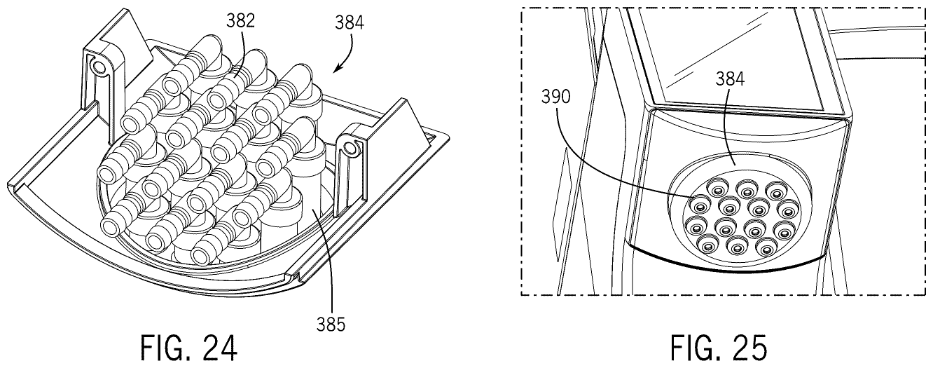

Each dispensing fitment 382, extension tube 385, or opening 390 can correspond to a container 326. In other words, there is a one-to-one relationship between each dispensing fitment 382, extension tube 385, or opening 390 and each container 326 so if there are six containers 326, then there are six dispensing fitments 382, extension tube 385, or opening 390. In the arrangement shown in FIGS. 24 and 25, there are fourteen dispensing fitments 382, fourteen extension tubes 385, and fourteen openings 390 in a dispensing array, one for each of the fourteen containers 326 housed within chambers 324a-324c. In other examples a fitment 382 can be associated with multiple containers 326.

The one or more dispensing fitments 382 or extension tubes 385 may be aligned within one or more rows or columns. In the arrangement shown in FIGS. 21-25, the dispensing fitments 382 or extension tubes 385 are aligned with three dispensing fitments or extension tubes 385 in a first and fourth row and four dispensing fitments 382 or extension tubes 385 in a second and third row. The dispensing fitments 382 or extension tubes 385 in the first and second row may be staggered or offset from each other and the dispensing fitments or extension tubes 385 in the third and fourth row may be staggered from each other as shown in FIG. 24. However, other configurations are possible. Each row of the one or more fitments 382 or extension tubes 385 may be at a different height from the base 318 of the food dispenser 310, as shown in FIG. 21. The dispensing fitments 382 in the first row may be at a first height H1. The dispensing fitments 382 in the second row may be at a second height H2. The dispensing fitments 382 in the third row may be at a third height H3. The dispensing fitments 382 in the fourth row may be at a fourth height H4. The heights of each row of dispensing fitments 382 or extension tubes 385 may increase from the first row to the fourth row. By varying the heights of the row of fitments or extension tubes 385, the fourth dispensing tubes 380 may be easily organized and prevented from being kinked.

In some cases, the fourth dispensing tubes 380 may be arranged based on a corresponding dispensing fitment or extension tubes 385. In a non-limiting example, the fourth dispensing tubes 380 are coupled to the first row of dispensing fitments can contact the inner surface 386 of second wall 388 while the fourth dispensing tubes 380 coupled to the second row of dispensing fitments 382 are arranged on top of the fourth dispensing tubing coupled to the first row of dispensing fitments. The fourth dispensing tubes 380 are coupled to the third row of dispensing fitments 382 that are arranged on top of the fourth dispensing tubes 380 coupled to the second row of dispensing fitments 382. The fourth dispensing tubes 380 are coupled to the fourth row of fitments 382 that are arranged on top of the fourth dispensing tubes 380 coupled to the third row of dispensing fitments. Alternatively, the fourth dispensing tubes 380 coupled to the first and second row of dispensing fitments can contact the inner surface 386 of second wall 388 while the fourth dispensing tubes 380 coupled to the third and fourth row of dispensing fitments are arranged on top of the fourth dispensing tubes coupled to the first and second rows of dispensing fitments. By aligning the dispensing fitments 382 in an array and organizing the fourth dispensing tubes 380 based on the array, the fourth dispensing tubes 380 coupled to the one or more outlets 364 of pumps 350 and the one or more dispensing fitments 382 may be easily organized and managed.

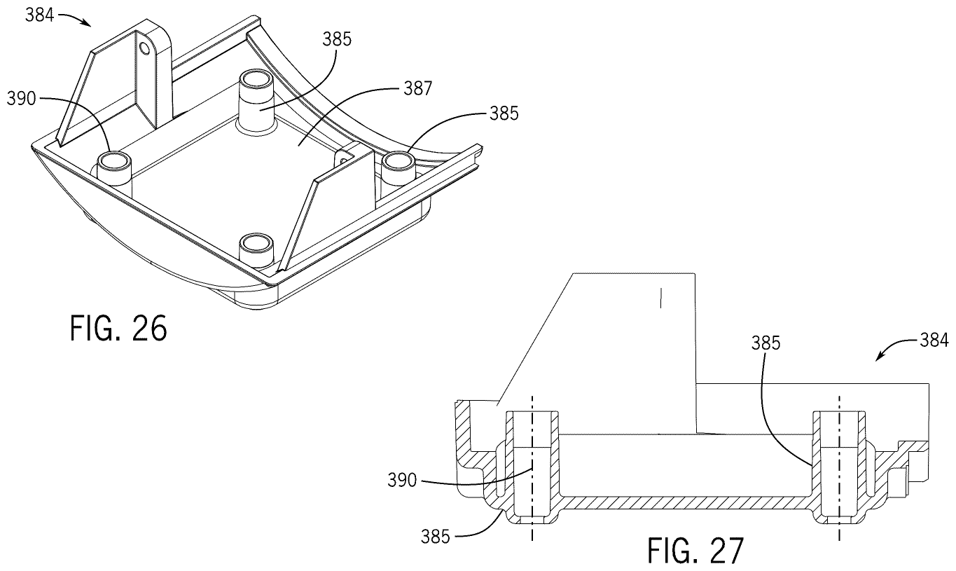

In some arrangements, as shown in FIG. 26, the dispenser head 384 can include four extension tubes 385. Each extension tube 385 can be positioned toward a corner of an inner surface or outer surface 387 of the dispenser head 384. In that regard, the extension tubes 385 can each define a nozzle of the dispenser head 384. In various cases, each extension tube 385 can correspond to one or more containers 326. In other cases, multiple extension tubes 385 can correspond to a container, such that a food product from a single container 326 can be dispensed simultaneously. Such arrangements can be beneficial for filling individual portion cups with a food product. For example, a food receiving container (e.g., a portion cup, bowl, plate, cup, etc.) can be arranged under each of the extension tubes 385 to allow food product to be dispensed into each portion cup. So, according to the present example, four portion cups can be positioned under each of the respective four extension tubes 385. A food product can then be dispensed from one or more containers 326 and into the portion cups simultaneously, via the extension tubes 385.

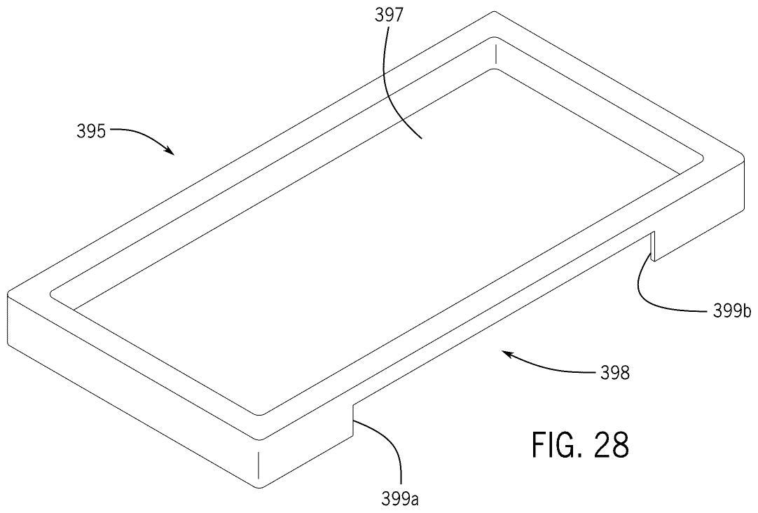

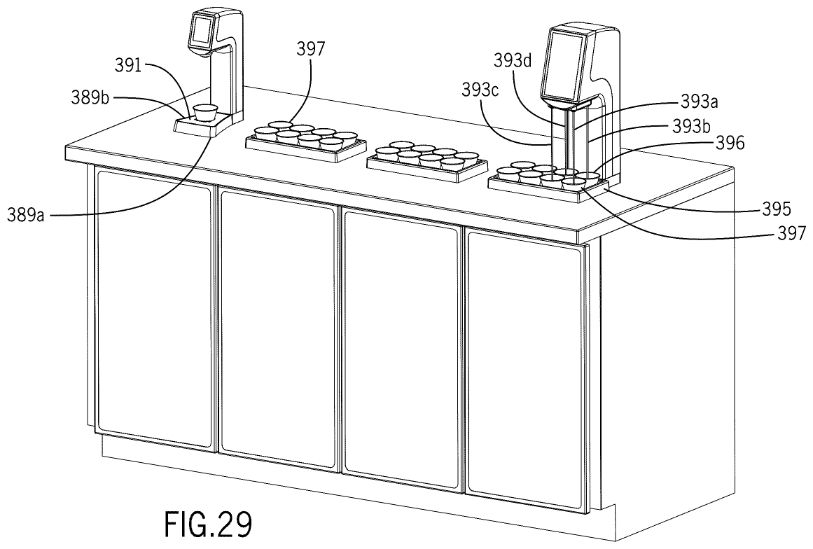

In some cases, an alignment device can be provided to allow a user to more easily align portion cups underneath nozzles of a dispenser head. Turning to FIG. 28, an optional tray 395 can be included with the food product dispenser 310. The tray 395 can be configured to hold one or more food receiving containers 396 (e.g., portion cups) configured to receive a food product from the food product dispenser 310. In various cases, the food product can be configured to be dispensed through a corresponding extension tube 385 (e.g., an opening 390 thereof) and into a corresponding food receiving container 396, as shown in FIG. 29.

In various arrangements, a top surface 397 of the tray 395 can be sized to contain a selected number (e.g., 1, 2, 4, 8, etc.) of food receiving containers 396. In the arrangement shown in FIGS. 28 and 29, the top surface 397 of the tray 395 is sized to hold eight receiving containers 396. However, the tray 395 can be configured to hold more or less receiving containers 396. When placed on the top surface 397 of the tray 395, the one or more receiving containers 396 can be arranged in a specific orientation or position relative to each other in order to correspond to an opening 390 of an extension tube 385. In a non-limiting example, as shown in FIG. 29, the one or more food receiving containers 396 are arranged in two rows and four columns. However, other arrangements are possible and within the scope of this disclosure. Additionally, the one or more food receiving containers 396 can be sized to be arranged in a specific orientation or position relative to each other in order to correspond to an opening 390 of an extension tube 385. In a non-limiting example, as shown in FIG. 29, the one or more food receiving containers 396 are sized such that eight food receiving containers 396 can be positioned within tray 395 and at least four receiving containers at a time correspond to an opening 390 of a corresponding extension tube 385 when the tray is 395 is placed under the dispensing head 384.

In some instances, each extension tube 385 can be positioned in the dispensing head 384 to correspond to a food receiving container 396 located on tray 395. In a non-limiting example, by arranging each extension tube 385 toward a corner, perimeter, edge, middle, or the like of the dispenser head 384, each extension tube 385 corresponds directly to a corresponding food receiving container 396 as denoted by lines 393a-d in FIG. 29. In the non-limiting example, shown in FIG. 29, each of the four extension tubes 385 corresponds to a food receiving container 396.

In some cases, a tray can be configured to engage with a base of a dispenser to align portion cups supported thereon with a dispenser head. That is, a tray can include alignment features to allow the tray to be arranged in one or more positions relative to a dispenser head. In that regard, the tray can include a first alignment feature that is configured to couple or align with a second alignment feature on the dispenser. Thus, for example, a first position of a tray can align a first set of portion cups to the dispenser head, a second position of a tray can align a second set of portion cups to the dispenser head, a third position of a tray can align a third set of portion cups to the dispenser head, and so on. In various cases, the tray 395 can further include an alignment feature configured as a slot 398 shown in FIG. 28. The slot 398 can be configured to fit over a drip pan 391 (e.g., a base, optional drip tray 110 or 210, support 320, or the like) of the food product dispenser 310. In various cases, the slot 398 can be sized to ensure that the one or more food receiving containers 396 align with the opening 390 of a corresponding extension tube 385. In a non-limiting example, by aligning or contacting a first edge 399a of slot 398 to a first edge 389a of the drip pan 391, a first four receiving containers 396 can be aligned with an opening 390 of a corresponding extension tube 385. This allows the first four receiving containers 396 to be simultaneously filled with a food product (e.g., a same food product or a different food product, or the like). The tray 395 can then be moved to align or contact a second edge 399b of slot 398 to a second edge 389b of the drip pan 391. By aligning or contacting the second edge 399b of slot 398 to the second edge 389b of the drip pan 391, a second four receiving containers 396 can be aligned with an opening 390 of a corresponding extension tube 385. This allows the second four receiving containers 396 to be simultaneously filled with a food product (e.g., a same food product or a different food product, or the like). The one or more receiving containers 396 can be filled faster and more efficiently. Although FIG. 29 shows four food receiving containers 396 being filled at a time, more or less food receiving containers 396 could be filled at a time and are within the scope of this disclosure. In other examples, different slots may be provided for different filling positions of the tray 395.

Turning back to the one or more pumps 350 of food dispenser 310, the one or more pumps 350 can include a motor shaft connecting portion that is specifically designed to receive the drive shaft of an electric drive motor 352 shown in FIGS. 14 and 15. When the motor drive shaft is inserted into the connecting portion of the pump 350, operation of the drive motor 352 causes an impeller within the pump 350 to rotate and thus pump the flowable food product through the pump 350 and out of the food product dispenser 310.

Each of the pumps 350 is driven by an electric drive motor 352 that is connected to a power supply 356. The drive motors 352 can preferably include an encoder or another type of sensor that allows for the monitoring of the rotation of the drive motor 352. The power supply 356, in turn, is connected to a utility power source through a conventional plug 392. The power supply 356 converts the utility power source to the required voltage and current to drive the motor 352.

In addition, the power supply 356 provides the required voltage and current to power the control module 312. The control module 312 can include various processors and control elements that allow for controlling the operation of the motors 352 and pump 350 and for receiving input from the control panel 314. The control panel 314 is operatively connected to the control module 312 such that user inputs from an operator are relayed to the control module 312. Based on the commands from the user, the control module 312 can control operation of the drive motors 352 and the pumps 350. In addition, the control module 312 is able to send information and signals to the control panel 314 for display to the user.

The one or more pumps 350 and/or drive motors 352 are controlled by the control module 312. In some examples, the control module 312 includes all of the control and processing components (e.g., power supplies, AC/DC converters, voltage converters, etc.) to control the pumps 350 or drive motors 352. The control components and the user control panel 314 allow for touchless or touch activation and the ability to modify the operation of the dispenser from the user control panel 314.

In some applications a dispensing head can include a user interface to allow a user to dispense a desired amount or type of food product. For example, FIG. 7 illustrates a user interface 226 of the control panel 208 which could be implemented on any of the food dispensers described herein. For example, in the configuration shown in FIG. 7, the user interface 226 of the control panel 208 includes up to fourteen selection buttons that allow the operator to select the type of liquid food product that will be dispensed. In the arrangement shown, these food products can include “Chocolate Caramel,” “Caramel” “Seasonal LTO,” “French Vanilla,” “SF Vanilla,” “Chocolate,” “Simple Syrup,” “Sugar,” “Salt,” or the like. Other products are considered and options could be included on the user interface. Accordingly, a user interface can be configured to include a different number of selection buttons, such as one, two, three, four, five, etc. buttons including with greater than fourteen buttons.

In addition to the selection buttons, the arrangement of the user interface shown in FIG. 7 can include separate size buttons for each of the products. The size buttons allow the user to control the amount of food product that will be dispensed into the vessel 202 positioned below the dispensing spout. The size buttons could include Small, Medium, and Large. Thus, if the user selects the Chocolate Carmel option, the user can then select a small, medium, or large volume of the liquid to be dispensed. The control panel 208 can further include a Free Pour button. The Free Pour button allows the user to manually dispense the food product from the food product dispenser. In the arrangement illustrated, the user interface and the series of buttons can be customized for the restaurant or food service facility. The button layout, size and labels can be modified as desired by the end user.

When a user selects the desired selection button and size button, the control module 208 selects the required pump for operation and makes a determination of the amount of time or the number of rotations the drive motor needs to operate to dispense the desired amount of the food product into the container or onto the food product. For an example, a large coffee with the addition of Carmel flavoring may require less product than a large coffee with Simple Syrup. Thus, if the user selects a large container and Chocolate Caramel, the control module 208 will determine the pump associated with Chocolate Caramel and the amount that needs to be dispensed.

Once the control module 208 determines the amount of flavoring that needs to be dispensed, the control module 208 initiates the operation of the drive motor or other component associated with the selected flavoring. In the case of flowable food products, the combination of the drive motor and pump are operable to dispense an accurately known volume of flowable food product for each rotation of the drive shaft. By counting the numbers of rotations of the drive shaft, the control module 208 and motor can accurately meter and control the amount of flowable food product being dispensed from the food product dispenser. In the case of granular food products, the drive motor, knob, opening, or other component are operable to dispense an accurately known volume of granular food product (e.g., for each rotation of a drive shaft or knob or an amount of time a drive shaft or knob are rotated or an opening is in an open position). By counting the numbers of rotations or determining an amount of time, the control module 208 can accurately meter and control the amount of granular food product being dispensed from the food product dispenser. In other examples, other operating parameters can be monitored by the control module 208 to ensure that a desired amount of food product is dispensed. Correspondingly, the dispenser can include associated sensors that can measure the operating parameter and communicate it to the control module 208.

In this manner, the control module 208 is able to accurately control the amount and volume of food product dispensed. Thus, the restaurant or food service facility can accurately and repeatedly dispense the desired amount of sauce or other food product onto a food item. This allows for consistency across multiple restaurant locations, which is a highly desirable feature of the present disclosure.

Other configurations of the single-serve food dispenser and multi-serve food dispenser are possible with more or less food products. In this way, the arrangements disclosed herein provide a modular food dispenser. By having a modular food dispenser, the food dispenser can be configured in a variety of different ways to dispense a food product to a customer. Correspondingly, it is appreciated that aspects of the various examples described herein can be combined in various ways to meet the dispensing requirements of a particular application, lending to the modular nature of the dispensing systems described herein.

As used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, the use of “including,” “comprising,” or “having” and variations thereof herein is meant to encompass the items listed thereafter and equivalents thereof as well as additional items. Unless specified or limited otherwise, the terms “mounted,” “connected,” “supported,” “attached,’ and “coupled” and variations thereof are used broadly and encompass both direct and indirect mountings, connections, supports, and couplings.

In this application, the use of the singular includes the plural unless specifically stated otherwise, and use of the terms “and” and “or” means “and/or” unless otherwise indicated. Moreover, the terms left, right, front, back, top, bottom, forward, reverse, clockwise and counterclockwise are used for purposes of explanation only and are not limited to any fixed direction or orientation. Rather, they are used merely to indicate relative locations and/or directions between various parts of an object and/or components. Additionally, terms such as first, second, third, are merely used to distinguish elements or components from each other and are not intended to imply an order, sequence or amount unless expressly stated otherwise.

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A food dispenser comprising:
a first chamber and a second chamber;
two or more containers contained within the first chamber;
at least one pump contained within the second chamber and coupled to a corresponding container of the two or more containers within the first chamber; and
a dispenser head attached to the second chamber and configured to dispense a food product from each of two or more containers, wherein the at least one pump is configured to pump a flowable food product from the corresponding container to the dispenser head.

2. The food dispenser of claim 1, wherein the first chamber is located above a counter and the second chamber is located below the counter.

3. The food dispenser of claim 1, wherein a housing comprises the first chamber and the second chamber.

4. The food dispenser of claim 3, wherein the first chamber comprises a first rack, a first connector coupled to the first rack, and a first tube coupling the first connector to the corresponding first container.

5. The food dispenser of claim 4, further comprising a second tube coupled to the first connector, wherein the second tube extends through a cutout of the first chamber and couples to a second connector coupled to an inlet of the at least one pump in the second chamber.

6. The food dispenser of claim 5, wherein the first tube is routed through a cutout in a first back wall of the first chamber and wherein the one or more second connectors are coupled to a second back wall of the second chamber.

7. The food dispenser of claim 5, further comprising a third tube and coupling an outlet of the at least one pump to a fitment of the dispenser head.

8. The food dispenser of claim 1, wherein the dispenser head comprises a plurality of fitments.

9. The food dispenser of claim 8, wherein the plurality fitments are arranged in at least one of one or more rows or one or more columns.

10. The food dispenser of claim 9, wherein one or more first fitments of the plurality of fitments in a first row are offset from one or more second fitments of the plurality of fitments in a second row.

11. The food dispenser of claim 9, wherein one or more first fitments of the plurality of fitments in a first row are at a first height from a base of the second chamber and wherein one or more second fitments of the plurality of fitments in a second row are at a second height different from the first height from the base of the second chamber.

12. The food dispenser of claim 11, wherein one or more tubes coupling an outlet of each pump of the at least one pump to a corresponding fitment of the plurality of fitments are arranged along an inner surface of the second chamber based on the first height of the first row and the second height of the second row.

13. The food dispenser of claim 1, further comprising a first container of the two or more containers configured to contain a granular food product, wherein the first container is coupled to the dispenser head, wherein the dispenser head is configured to dispense the granular food product.

14. A food dispenser comprising:
at least one first chamber removably coupled to a second chamber;
two or more containers contained within the at least one first chamber;
at least one pump contained within the second chamber and coupled to a corresponding container of the two or more containers within the first chamber;
a dispenser head attached to the second chamber and configured to dispense a food product from each of two or more containers; and
a controller configured to control the at least one pump to pump a flowable food product from the corresponding container to the dispenser head.

15. The food dispenser of claim 14, wherein the pump comprises a motor, and wherein the controller is configured to control the motor of the at least one pump to pump a predetermined amount of flowable food product from the corresponding container through the dispenser head to a vessel.

16. The food dispenser of claim 15, wherein the controller is configured to control the motor of the at least one pump in response to at least one of a detection of the vessel under the dispenser head or a user selection of a product.

17. The food dispenser of claim 14, further comprising a first container of the two or more containers configured to contain a granular food product, wherein the first container is coupled to the dispenser head, wherein the dispenser head is configured to dispense the granular food product.

18. The food dispenser of claim 17, wherein the controller is configured to control at least one of a motor coupled to the first container, a knob coupled to the first container, or an opening of the dispenser head coupled to the first container to dispense a predetermined amount of granular food product from the first container to the dispenser head of the at least one pump to pump a predetermined amount of flowable food product from the corresponding container through the dispenser head to a vessel.

19. A food dispenser system comprising:
a first chamber and a second chamber;
two or more containers contained within the first chamber;
at least one pump contained within the second chamber and coupled to a corresponding container of the two or more containers within the first chamber; and
a dispenser head attached to the second chamber and configured to dispense two or more food products simultaneously, wherein the at least one pump is configured to pump a flowable food product of the two or more food products from the corresponding container to the dispenser head.

20. The food dispenser system of claim 19 further comprising an alignment device configured to align two or more vessels with a corresponding opening of the dispenser head, wherein the dispenser head is configured to dispense a corresponding food product into the two or more vessels simultaneously.
